(19) United States
(12) Patent Application Publication
(10) Pub. No.: US 2003/0074289 A1
(43) Pub. Date: Apr. 17, 2003

(54) Method of abatement on accounts receivable

(75) Inventors: Yeun-Jonq Lee, Hsin Tien City (TW); Fang-Chen Tsao, Hsin Tien City (TW); Hui-Shan Ni, Hsin Tien City (TW)

Correspondence Address: DENNISON, SCHULTZ & DOUGHERTY, 1745 JEFFERSON DAVIS HIGHWAY, ARLINGTON, VA, 22202, US

(73) Assignee: Via Technologies, Inc.

(21) Appl. No.: 10/158,146

(22) Filed: May 31, 2002

(30) Foreign Application Priority Data
Oct. 17, 2001 (TW) 90125717

(51) Int. Cl. G06F 17/60

(52) U.S. Cl. 705/35

(57) ABSTRACT

The present invention is a method of abatement on accounts receivable. It is applied in a computer system and comprises the following steps. First, the sifting terms of the accounts received are entered into the computer system. Then, the accounts received are produced based on the sifting terms. From the accounts received being produced, accounts received for abatement are produced based on the sifting terms. Next, accounts received for abatement are produced based on the sifting terms. Accounts receivable are produced based on the sifting terms of accounts received. The accounts receivable for abatement are produced. Then, the total amount of the accounts received are produced. The total amount of the produced accounts receivable is abated from the total amount of the produced accounts received.

### FIELD OF THE INVENTION

The present invention relates to a method of abatement on accounts receivable, and more specifically, a method for the documentation of accounts receivable for application in an Enterprise Resource Planning (ERP) system.

### BACKGROUND OF THE INVENTION

Accounts receivable are the accounts to be received deriving from the business of providing services or selling products. After receiving the clients' payments, the accounts received corresponding to the accounts receivable must be abated in the financial system.

The method of abatement of accounts receivable in the conventional system is based on a client's check or remittance records. The accountant enters the system of abatement on accounts receivable to check on the details of all the concluded accounts receivable and accounts payable of the client and then selects the information of one or more accounts to be abated. Then, the accountant manually calculates the amount of every account being abated including differences in currencies and cash discounts, and inputs the amount of each account being abated, and finally concludes the accounts in the system. To abate the accounts payable, a negative amount must be inputted.

The following example shows the typical flow of the process on accounts receivable being abated. (Please refer to FIG. 1):

As shown in FIG. 1, first, the user initiates the system of documentation on accounts receivable in the computer, proceeding the method of abatement on accounts receivable (step 102). Then, based on the information of accounts received (check records or a bank confirmation of the balance check sheet), the user checks on the details of accounts receivable and accounts payable being concluded for the client in the system for abatement (step 104).

Next, the user selects the information of one or more accounts to be abated in accordance with the detailed information of the concluded accounts of accounts receivable and accounts payable being checked under the name of the client (step 106). Next, the user manually calculates the amount of each abatement including differences in currencies and cash discounts (step 108). Then, according to the account to be abated, the user inputs the amount of abatement for each account (step 110). Finally, the user concludes the accounts in the system of abatement on accounts receivable (step 112).

The conventional method of abatement on accounts receivable has a great potential for error due to mistakes that may be made by the accountant. Therefore, it is particularly important to solve the problem of the conventional method of abatement on accounts receivable.

### SUMMARY OF THE INVENTION

The object of the invention is to provide a method of abatement on accounts receivable so as to sift out the related accounts information of accounts receivable and account payable based on the sifting parameters set by the user to avoid accounts receivable being doubly or wrongly abated by mistake.

Another object of the invention is to provide a method of abatement on accounts receivable so as to automatically calculate the profit and loss of the remittance accepted between the date of shipment and concluded accounts to the date of the client's payment. The invention can then find out if the client is eligible for a cash discount in accordance with the date of the client's payment and automatically figure out the discount amount based on the conditions of the discount, thereby saving time and money.

The invention provides a method of abatement on accounts receivable comprising the following steps: inputting the accounts received sifting terms to sift out the accounts received that correspond to their matching accounts. Selecting the accounts received that are to be abated from the accounts received that match the parameters specified by the account received sifting terms. Accounts receivable matching their corresponding accounts are sifted out based on accounts received sifting terms. Selecting accounts receivable that can and will be abated. Calculating the total amount of the selected accounts received. Abating the amount of the selected accounts receivable that can be abated by the total amount of the selected accounts received.

The above-mentioned sifting terms on accounts received comprises the information on clients or the currency of accounts received. The content of accounts receivable matching accounts received based on sifting terms can be amended. Moreover, the above-mentioned method also comprises the following steps before inputting the sifting terms for accounts received: Inputting at least one piece of information concerning accounts received and saving this information of accounts received in the computer. The information of accounts received comprises notes number, notes due date, billing bank, billing number, billing drawer, currency of accounts received or amount of accounts received. The accounts received comprise a client's check or bank confirmation of a balance check sheet.

Furthermore, the method comprises running the following steps after the selected amount of accounts receivable to be abated are written-off from the total amount of the selected accounts received: Providing a ledger preview, the calculation formula of balancing debit and credit for verification purposes. The method also comprises executing the following steps after the selected amount of accounts receivable to be abated is abated from the total amount of the selected accounts received: locating the detailed accounts of every selected accounts receivable to be partially abated, selecting the detailed accounts to be abated, abating the selected accounts receivable to be abated and the detailed accounts of the total amount of the selected accounts received.

### BRIEF DESCRIPTION OF THE DRAWINGS

FIG. 1 is a flow chart of the abatement on accounts receivable in accordance with the prior art;

FIG. 2 illustrates the accounts received, on the screen provided, by the method of abatement on accounts receivable in the system of abatement on accounts receivable in accordance with an embodiment of the present invention;

FIG. 3 illustrates the accounts payable to be abated, on the screen provided, by the method of abatement on accounts receivable in the system of abatement on accounts receivable in accordance with an embodiment of the present invention;

FIG. 4 illustrates the other listed records, on the screen provided, by the system of abatement on accounts receivable in the method of abatement on accounts receivable in accordance with an embodiment of the present invention;

FIG. 5 illustrates the accounts receivable that can be abated, on the screen provided, by the system of abatement on accounts receivable in the method of abatement on accounts receivable in accordance with an embodiment of the present invention;

FIG. 6 illustrates the accounts receivable partially abated, on the screen provided, by the method of abatement on accounts receivable in accordance with an embodiment of the present invention;

FIG. 7 illustrates the preview of the listed records, on the screen provided, the system of abatement on accounts receivable in the method of abatement on accounts receivable in accordance with an embodiment of the present invention;

FIG. 8A to FIG. 8B illustrate the flow chart of the method of abatement on accounts receivable in accordance with an embodiment of the present invention;

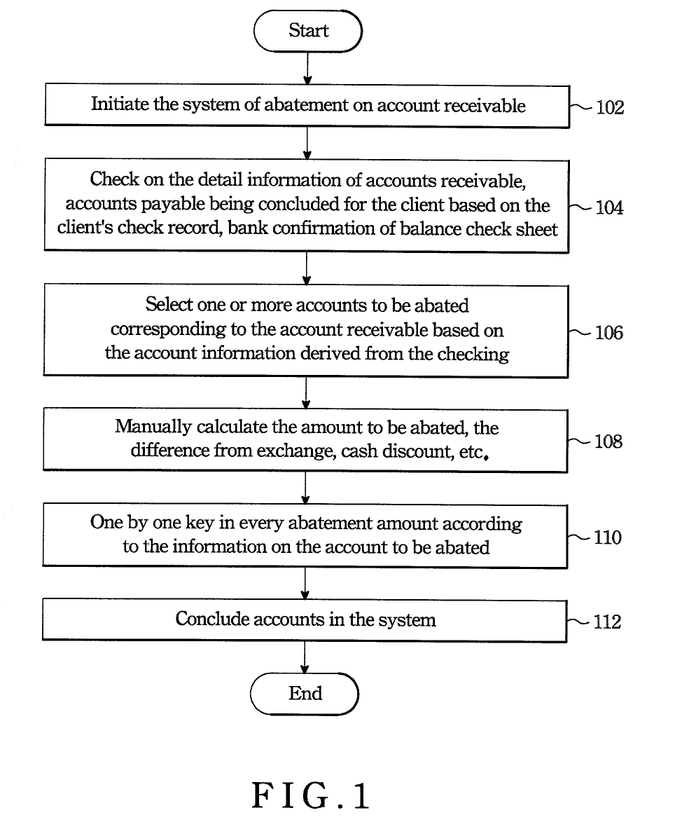

### DETAILED DESCRIPTION OF THE INVENTION

The object of the invention is to provide a method of abatement on accounts receivable so as to sift out related account information of accounts receivable. Accounts payable, which are based on the sifting terms set by the user, avoid accounts received from being doubly or wrongly abated by mistake.

Another object of the invention is to provide a method of abatement on accounts receivable so as to automatically calculate the profit and loss of the remittance accepted between the date of shipment and concluded accounts to the date of the client's payment, and find out if the client is eligible for a cash discount in accordance with the date of the client's payment, and to figure out the discount amount, based on the conditions of discount. This automatic process saves time and money.

The features of the invention are: integrating the management on accounts to be abated, providing automatic abatement with a computer system, abatement of detail on products, saving the trouble of manually processing and identifying the ownership of the various accounts.

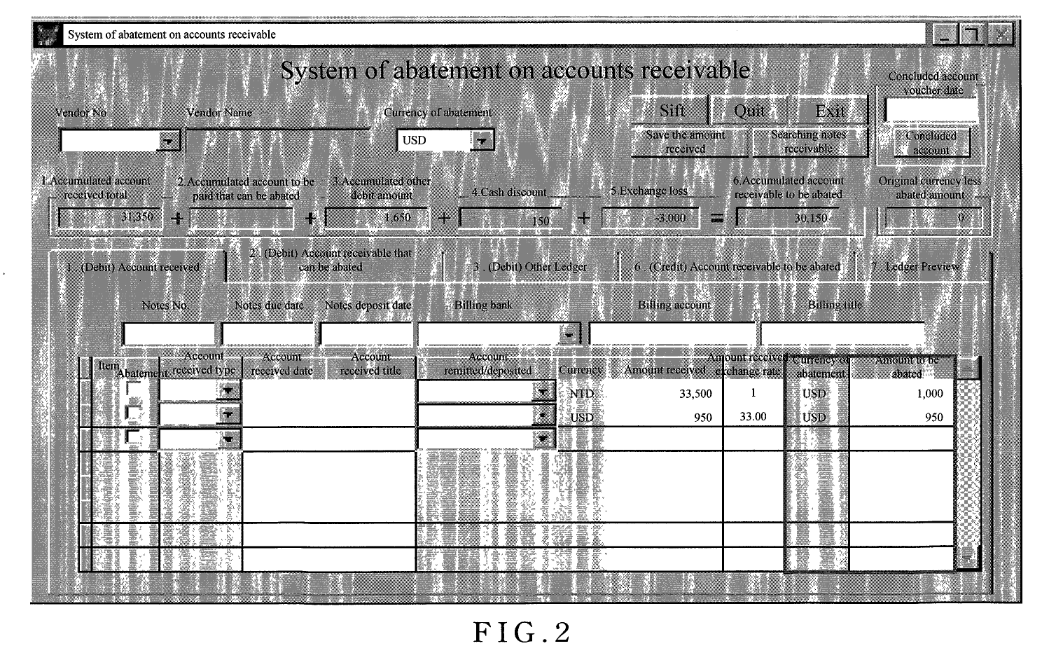

The method of abatement on accounts receivable in the present invention can be applied in an Enterprise Resource Planning (ERP) system. The preferred embodiment is described in detail in FIGS. 2˜7, illustrating a series of display pictures according to the system of the present invention.

When a user enters an entry into the system of accounts receivable, the closing adjustment on accounts receivable is displayed on the screen, as shown in FIG. 2. The system allows the user to select at least one of the following functions: accounts received (for debit), account payable to be abated (for debit), other ledger information (for debit), accounts receivable to be abated (for credit), and ledger preview.

If the user selects to run the function of accounts received (for debit), they input sifting terms such as client, currency, etc. as the selection item of accounts received (for debit) in the system of abatement on accounts receivable and push the “sifting” button. Then, all the data matching the sifting terms on accounts received being saved, but not yet being entered into the ledger, will be shown for the user to select or amend. Furthermore, the user can input the subsidiary ledger of accounts received (such as the information of notes number, notes due date, billing bank, billing account, bill drawer, currency and amount of accounts received.). The user can clicks the “save accounts received” button to save the subsidiary ledger of accounts received in the system of abatement on accounts receivable.

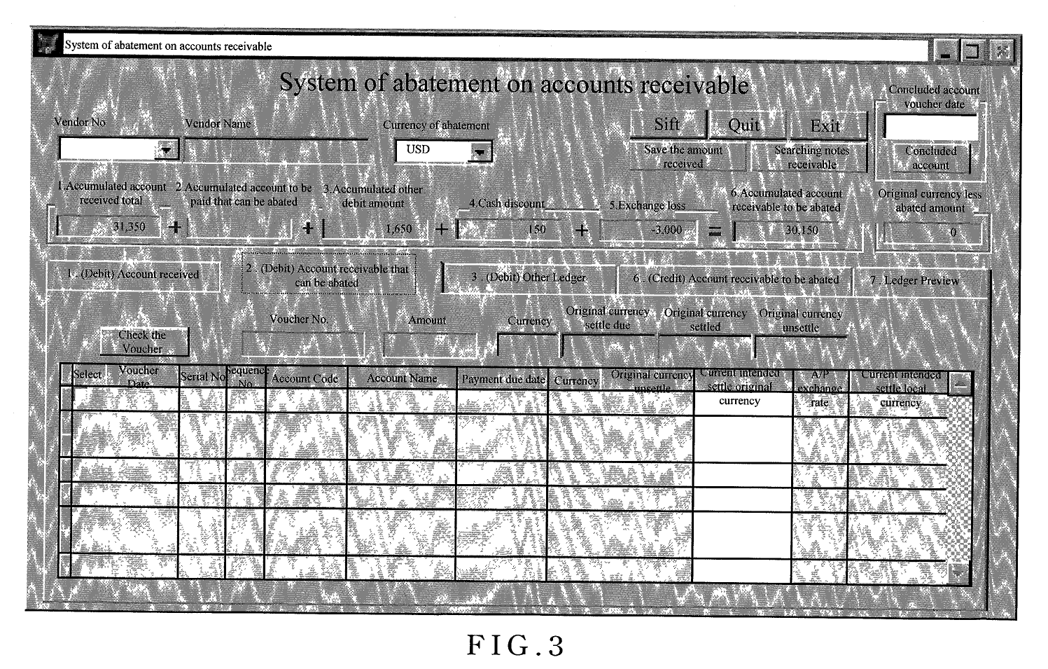

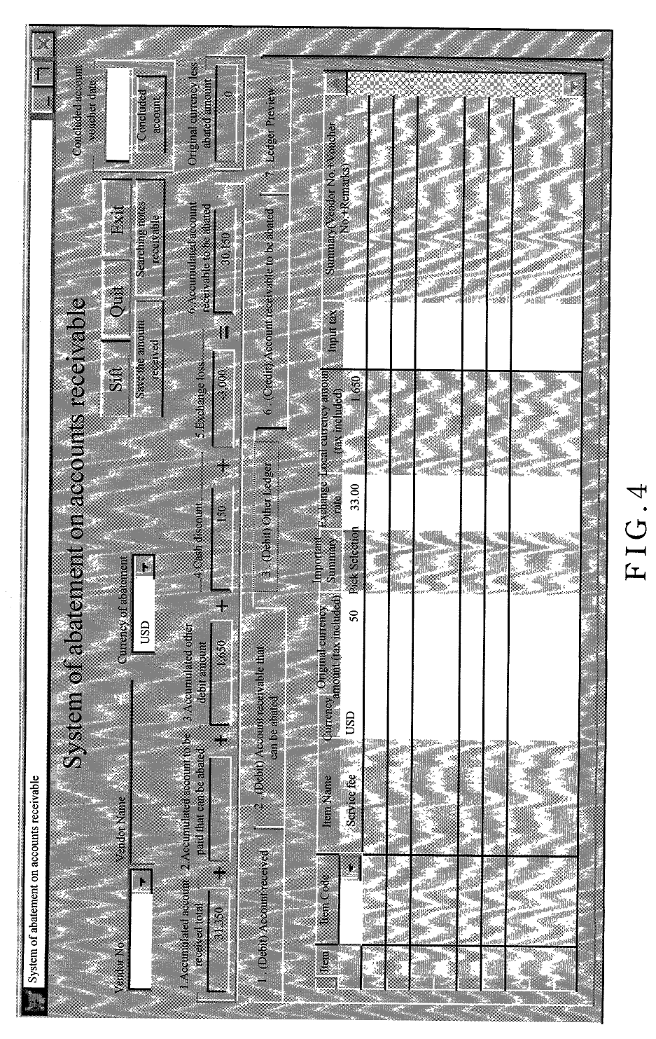

When the user clicks the “account payable to be abated (for debit)” and “other ledger information (for debit)” buttons separately, the system of documentation on accounts receivable will list out related account information one by one, of all accounts payable from the client to be abated, as shown in FIG. 3, and other debit accounts total amount, as shown in FIG. 4, for the user to select.

It is worthy of note that the system of abatement on accounts receivable will separately calculate the accumulated amount of accounts received, the accumulated amount of accounts payable to be abated and other accumulated amounts of the debit (which will be shown separately in the column of “total amount of accounts received”, “total amount of account payable to be abated” and “other total amounts of the debit”) based on the user's selection on the accounts received, accounts payable and other debit accounts, as shown in FIGS. 2˜4.

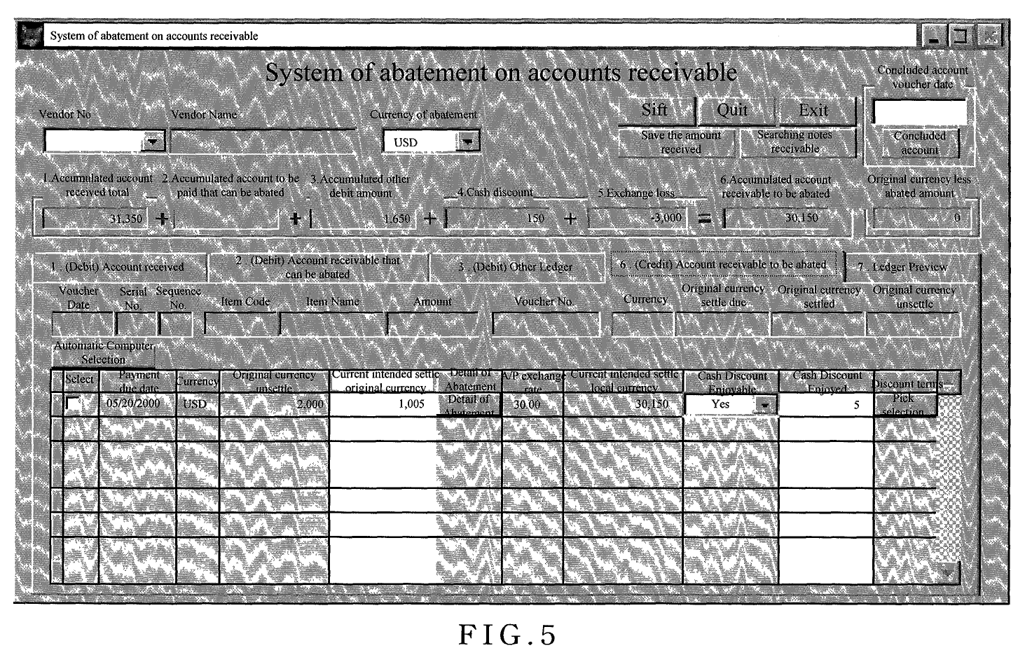

When the user clicks the “accounts receivable to be abated (for credit)” button, the system of abatement on accounts receivable will list out all of the client's accounts receivable (as shown in FIG. 5). Alternatively, the user may click the “computer auto selection” button to let the system of abatement on accounts receivable automatically select the accounts receivable to be abated. The computer auto selection method comprises a “sequential selection method” which will select accounts in sequence or the user may select accounts to be abated from the client's accounts receivable to be abated. After accounts to be abated are selected, the system of abatement on accounts receivable will automatically calculate the profit and loss of the remittance accepted, cash discount and amount of abatement (including the accumulated amount of accounts received, accumulated amount of accounts payable to be abated, other accumulated amount of accounts to be abated, etc.). The amount of the selected accounts receivable to be abated will be abated from the selected accounts received, the accounts payable to be abated and all other accounts to be abated, based on the information of the profit and loss of the remittance accepted, cash discount and amount of abatement.

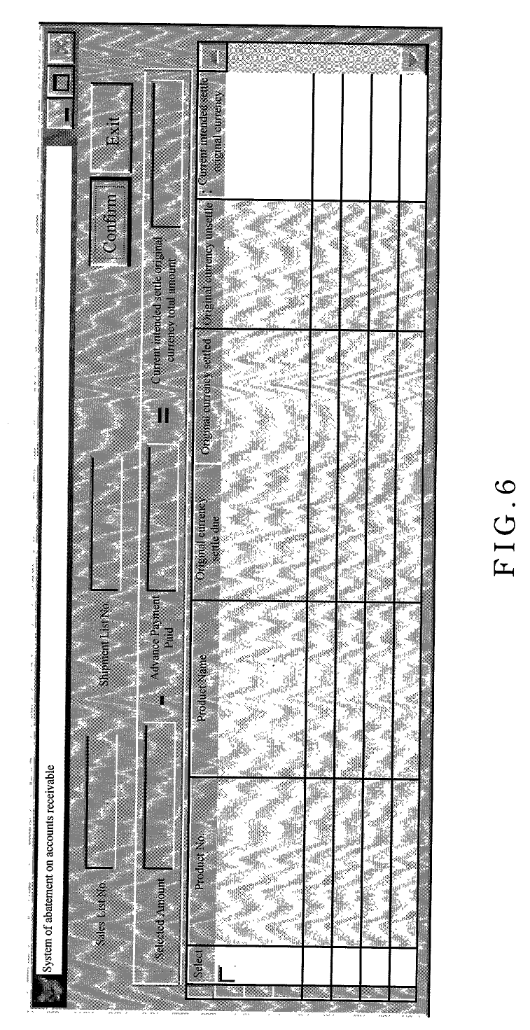

In case of a special demand or an insufficient amount of accounts received, which requires a certain accounts receivable amount to be partially abated, as shown in FIG. 5, the user may click the “subsidiary ledger of intended abatement” button to move the partial abatement on accounts receivable, as shown in FIG. 6. In this way, the user may proceed with a subsidiary ledger of the intended abatement on all the sub-products in the account. At this time, the system of abatement on accounts receivable will list out the subsidiary ledger of the accounts receivable. The user may click the “computer auto selection” button (not shown) to allow the system of abatement on accounts receivable to automatically select the details on the accounts receivable to be abated (Note: the method of automatic selection in the computer comprises a sequential selection method. The user may also select the subsidiary ledger on the account receivable to be abated. After the selection is completed, the system of abatement on accounts receivable will automatically calculate the entered information, such as the profit and loss of the remittance accepted, cash discount and amount of abatement and abate the total amount of the selected accounts received, accounts receivable and other accounts for debit all out based on said information of the profit and loss of the remittance accepted, cash discounts and amount of abatement.

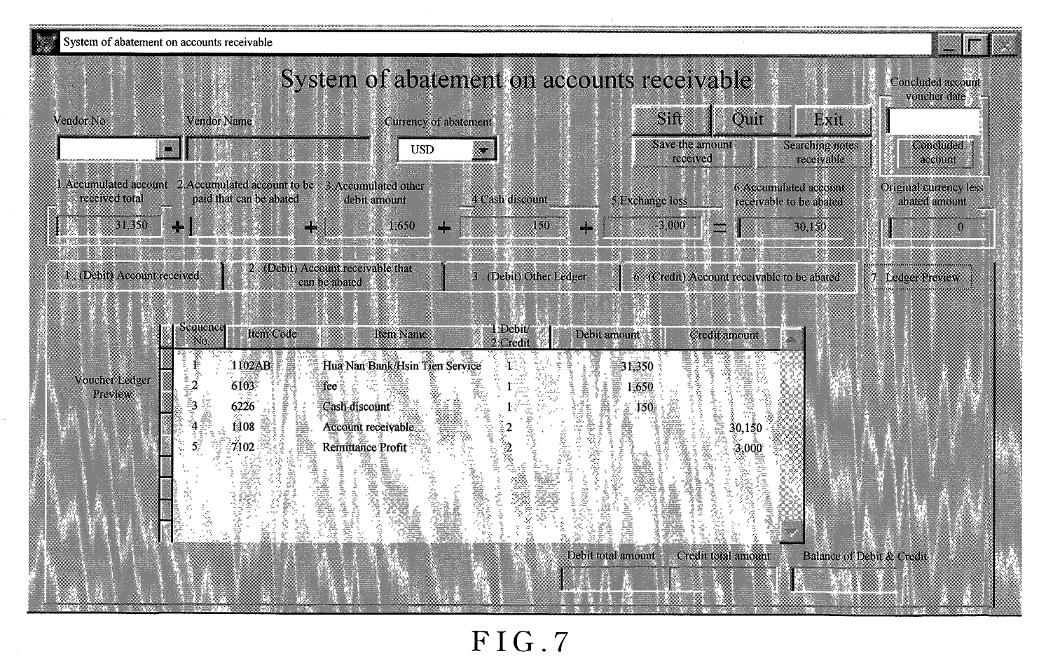

In addition, the user may click the “preview of journalizing” button and apply the trial balance of credit and debit to proceed with primary information checking (which includes the checking of the detailed information in the preview of journalizing on voucher, total debit amount, total credit amount and the difference between total debit amount and total credit amount, as shown in FIG. 7) based on the preview of journalizing and credit & debit balancing calculation formula, as shown in FIG. 7. Then, the user may input the date in the “concluded accounts voucher date” column and click the “conclude accounts” button, the process of concluding accounts that are the selected accounts received is completed.

In the result of the calculation of the system of abatement on accounts receivable, the accumulated amount of accounts received, accounts payable to be abated, other accumulated amount for debit cash discount and the loss of the remittance accepted combined must be equal to the accumulated amount of accounts receivable to be abated.

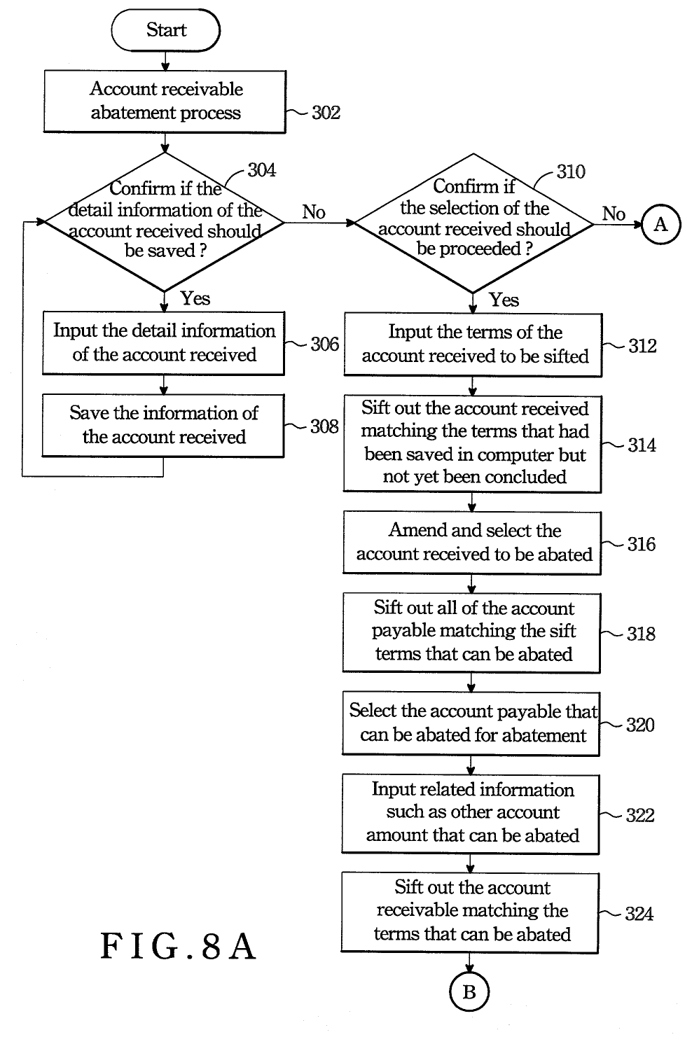

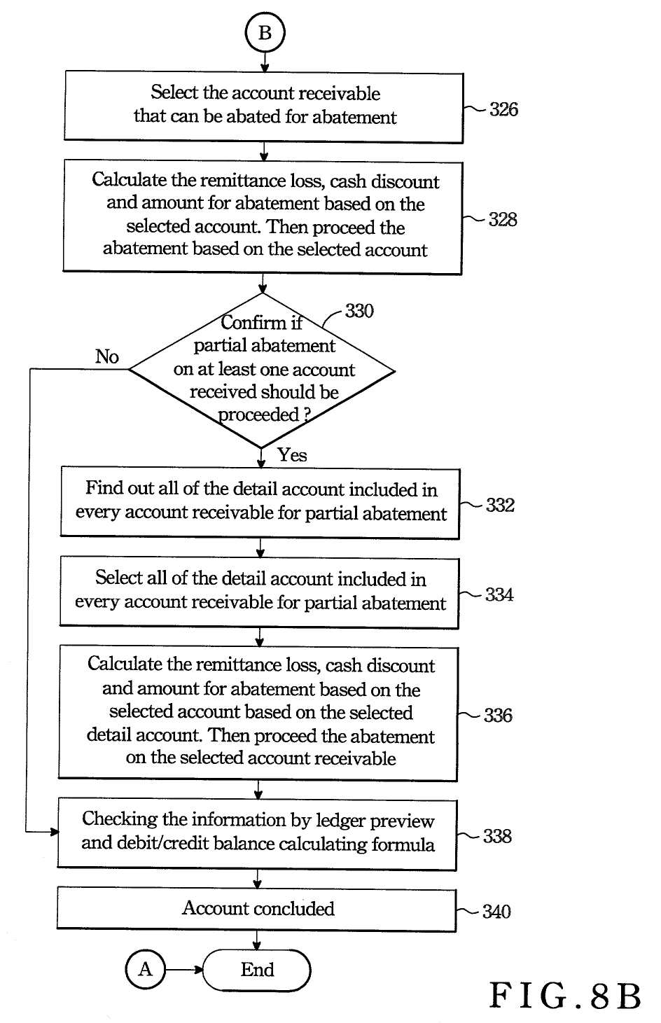

A preferred embodiment of present invention, as described above, is illustrated in FIGS. 8A˜8B).

As shown in FIGS. 8A˜8B, first the user enters the entry in the system of abatement on accounts receivable to proceed with the abatement on accounts receivable (step 302). Next, the user confirms if they want to save the detailed information of the client's check or bank confirmation of a balance check sheet on the accounts received (such as check number, check expiration date, check drawer bank, check drawer account, check drawer name, currency and amount of accounts receivable) in the system (step 304). If yes, the user will input the detailed information into the system (step 306), save the information (step 308) and go back to step 304. Otherwise, the user will need to confirm if he wants to proceed with the selection of accounts received (step 310).

If the user decides not to proceed with the selection of accounts received, the process of abatement on accounts receivable will end. Otherwise, the user must input the sifting terms of accounts received (such as the information of client or currency of accounts received) into the system (step 312). After the user completes this process, the system of abatement on accounts receivable will sift out all of the information concerning the accounts received being saved, but not yet concluded, that matches the sifting terms (step 314). Then, the user selects accounts received to be abated and partially amends them (step 316).

Next, the user allows the system of abatement on accounts receivable to sift out the accounts payable to be abated that match the sifting terms appointed by the user (step 318). Then, the user selects the accounts payable to be abated that they desire to abate (step 320). The user now inputs the related information concerning other amounts of accounts (also called other debit amount) to be abated in the system (step 322).

Next, the user allows the system of abatement on accounts receivable to sift out accounts received to be abated that match the appointed sifting terms entered by the user (step 324). Then, the user will manually or automatically select accounts receivable to be abated that are required to be abated (step 326). Then, the system will automatically calculate the information concerning the profit and loss of the remittance accepted, cash discount and amount of abatement based on the selected accounts. Basically, it automatically calculates the amount of the profit and loss of the remittance accepted and cash discount based on the selected accounts receivable; and the amount to be abated based on the selected accounts received, accounts payable to be abated and all other accounts to be abated. The system will also abate the amount of accounts receivable to be abated based on the information of the profit and loss of the remittance accepted, cash discount and amount of abatement by the amount of selected accounts received, accounts payable and other accounts to be abated (step 328).

Then, the user confirms if they want to proceed with a partial abatement on the amount of at least one account receivable (step 330). If the user wants to proceed with the partial abatement, they must allow the system to locate every account receivable that is required to be partially abated including all the detail accounts (i.e. the detail information on all of the sub-products) (step 332). Next, the user manually or automatically selects the detailed accounts of all aforesaid accounts receivable to be abated (step 334). The system automatically calculates the information of the profit and loss of the remittance accepted, cash discount and amount of abatement based on the selected accounts. Basically,. it automatically calculates the amount of the profit and loss of the remittance accepted and cash discount based on the selected accounts receivable, and the amount to be abated based on the selected accounts received, accounts payable to be abated and all other accounts to be abated. The system will also fully abate the amount of selected accounts received, accounts payable and other debit accounts based on the information of the profit and loss of the remittance accepted, cash discount and amount of abatement (step 336). Then, the user checks on the information based on the information found in the ledger preview and debit and credit balancing calculation formula provided by the system (step 338). Next, the user saves the result in the system and completes the concluded accounts of the selected accounts received (step 340).

If the user does not wish to proceed with a partial abatement on a certain account receivable, they may proceed to step 338 and step 340 directly.

The uniqueness of the present invention, its superiority to the prior art, and the drawbacks it overcomes are described as follows:

(1) The present invention automatically sifts out the related information of accounts payable and accounts receivable based on the client and currency used. Not only can it reduce the scope by selection, calculate total amounts for verifying various kinds of accounts and vouchers, but also it can avoid mistakes of double or wrong abatement.

(2) Accounts received that have not yet been concluded can be saved and are automatically shown in the system in the next account abatement process to avoid neglecting any accounts received that are to be concluded and to proceed with the abatement on multiple accounts received by the multiple accounts receivable.

(3) The present invention provides the function of “automatic abatement in a computer”. Every account receivable that is to be abated can be abated in sequence by the system. It simplifies the procedure of a user's distribution on the amount for abatement and makes records of every amount being abated. Not only can it avoid the mistake of double abatement, it can also continue unfinished abatements to avoid confusion between accounts that have not yet been completely abated.

(4) As for the amount of certain accounts receivable requiring partial abatement due to an insufficient amount received or by a user's request, the present invention provides partial abatement on accounts receivable. Not only can it perform automatic calculations of detailed amounts to be abated on each product and each account, it also provides the user with the ability to amend the results of the detailed abatement.

(5) The present invention provides an automatic calculation for the profit and loss of the remittance accepted between the date of shipment and concluded accounts to the date of the client's payment. It can calculate if a client is eligible for a cash discount, based on the date of the client's payment and the terms of the discount. It eliminates the procedure of manual checking and calculation.

(6) The present invention provides instant debit and credit balancing formulas. It also provides guides for inputting information such as accounts and abatement selection, and avoids potential causes for error. Users may input or partially amend the detailed information based on no existing data or doubtful part in the formula. After inputting all the information and the completion of the amending, the user may preview the accounts with the ledger preview function to check the accuracy of the information before the accounts are concluded.

(7) The present invention provides the abatement of different currencies as accounts received are inputted, in the case of foreign currency transactions.

It is to be understood that while a certain preferred embodiment of the invention is illustrated, various changes or modifications may be made without departing from the scope of the invention and the invention is not to be considered limited to what is shown and described in the specification and drawings.

What is claimed is:

1. A method of abatement on accounts receivable in a computer system, said method comprising the steps of:
inputting the sifting terms for accounts received into said computer system;
said computer system gathering accounts received matching said accounts received sifting terms based on the sifting terms of accounts received;
selecting said accounts received to be abated from said accounts received matching accounts received sifting terms;
said computer system sifting out accounts payable to be abated matching said accounts received sifting terms;
selecting accounts payable to be abated that can be abated;
said computer system sifting out all accounts receivable to be abated matching said sifting terms of accounts received;
selecting accounts receivable to be abated that can be abated;
inputting related information concerning amounts of other accounts to be abated;
said computer system calculating the profit and loss of the accepted remittance and cash discount of the selected accounts receivable to be abated;
said computer system calculating the amount of abatement based on the selected accounts, said accounts payable to be abated and said other accounts to be abated, wherein said amount comprises the information of said accounts received, said accounts payable to be abated and said other accounts to be abated;
said computer system abating said amount of said selected accounts receivable from said selected accounts received, abating said amount of accounts receivable that can be abated from said selected accounts received, said accounts payable and said other accounts to be abated, based on the information of said amount for abatement, the profit and loss of the remittance accepted and cash discount of said selected accounts receivable to be abated.

2. The method of claim 1, wherein said accounts received sifting conditions further comprises the client's information or the currency of accounts received;

3. The method of claim 1, wherein the content of accounts receivable to be abated matching said accounts received sifting conditions can be amended;

4. The method of claim 1, wherein the total amount of accounts receivable to be abated are abated by the total amount of the sifted accounts received, accounts payable to be abated and other accounts to be abated in accordance with the said method, further comprising the execution of the following steps:
said computer system providing a preview of journalizing and debit and credit balancing calculating formula for verification purposes.

5. The method of claim 1, wherein said amount of said selected accounts receivable to be abated is written off from said amount of said selected accounts received, said accounts payable and said other accounts, further comprising the execution of the following steps:
said computer system locating all of the detailed amounts of every said selected accounts receivable to be abated requiring partial abatement;
selecting said detailed accounts to be abated;
said computer system calculating the selected accounts received to be abated and the profit and loss of the remittance accepted and cash discount of said accounts;
said computer system abating the amount of said selected accounts receivable to be abated and the amount of said detailed accounts from the amount of said selected accounts received, accounts payable and said other accounts to be abated based on said amount for abatement, said selected accounts receivable to be abated and the information of the profit and loss of the remittance accepted and cash discount of said accounts;

6. The method of claim 1 comprising the execution of the following steps before inputting the sifting conditions of accounts received:
inputting the detailed information of at least one account received that had not yet been saved in said computer system;
saving in said computer system, the detailed information of at least one accounts received.

7. The method of claim 6, wherein said accounts received comprises the information of check number, check expiration date, check issuing bank, check issuing account, check issuing person's name, currency or amount of account.

8. The method of claim 1, wherein said accounts received comprises a client's verification or a bank confirmation of balance check sheet.

9. The method of abatement on accounts receivable, wherein said method comprises the steps of:
inputting the sifting terms of accounts receivable into said computer system;
said computer system sifting out accounts received matching said accounts received sifting terms based on said accounts received sifting terms;
selecting from accounts received matching said account received sifting terms, and accounts received to be abated;
said computer system sifting out accounts payable to be abated matching said accounts received sifting terms;
selecting accounts payable that can be abated or are to be abated;
said computer system calculating the total amount of the selected accounts received;
said computer system abating the amount of selected accounts receivable to be abated from the total amount of selected accounts received.

10. The method of claim 9, wherein said accounts received sifting terms comprises the information of clients or the currency of accounts.

11. The method of claim 9, wherein the content of said accounts receivable to be abated matching said sifting terms of accounts received can be amended.

12. The method of claim 9 further comprises the execution of the following steps after abating the amount of the selected accounts receivable to be abated from the total amount of said selected accounts received:
said computer system providing the information in a ledger preview and debit and credit balancing calculating formulas for verification purposes.

13. The method of claim 9, wherein said method further comprises the execution of the following steps after abating the amount of accounts receivable to be abated from the total amount of said accounts received:
said computer system locating all of the detailed accounts in every partial abatement selected from said accounts receivable to be abated;
selecting said detailed account to be abated;
said computer system abating the amount of said selected accounts receivable to be abated and the detailed accounts from the total amount of said selected accounts received to be abated.

14. The method of claim 9 further comprises the execution of the following steps before inputting said accounts received sifting terms:
inputting at least one piece of detailed information concerning accounts received in said computer system;
saving said detailed information of at least one account received in said computer system.

15. The method of claim 14, wherein said accounts received comprises the information of notes number, notes due date, billing bank, billing account, bill drawer's name, currency or amount of accounts in said detailed information.

16. The method of claim 9, wherein said accounts received comprises a client's check or bank confirmation of a balance check sheet.

17. The method of abatement on accounts receivable, wherein said method applied to a computer system comprising at the following steps:
inputting accounts received sifting terms into said computer system;
said computer system sifting out accounts received matching said accounts received sifting terms based on the sifting terms of accounts received;
selecting said accounts received to be abated from said accounts received matching accounts received sifting terms;
said computer system sifting out accounts payable to be abated matching said accounts received sifting terms;
selecting accounts payable to be abated that can be abated;
said computer system sifting out all of accounts receivable to be abated matching said sifting terms of accounts received;
selecting accounts receivable to be abated that can be abated;
said computer system calculating the profit and loss of the accepted remittance and the cash discount of the selected accounts receivable to be abated;
said computer system calculating the amount of abatement based on the selected accounts, said accounts payable to be abated, wherein said amount comprises the information of said accounts received and said accounts payable to be abated;
said computer system abating said amount of said selected accounts receivable from said selected accounts received, abating said amount of accounts receivable that can be abated from said selected accounts received, said accounts payable, based on the information of said amount for abatement, the profit and loss of the accepted remittance and the cash discount of said selected accounts receivable to be abated.

18. The method of claim 17, wherein said accounts receivable sifting terms comprises the information of client or currency.

19. The method of claim 17, wherein the content of said accounts receivable to be abated matching said accounts received sifting terms can be amended.

20. The method of claim 17 further comprising the execution of the following steps after abating the amount of accounts receivable to be abated from the total amount of said accounts received:
said computer system providing the information in a ledger preview and debit and credit balancing calculating formulas for verification purposes.

21. The method of claim 17 further comprising the execution of the following steps after abating the amount of accounts receivable to be abated from the total amount of said accounts received:
said computer system locating all of the detailed accounts in every partial abatement selected from said accounts receivable to be abated;
selecting the detailed accounts to be abated;
said computer system calculating the profit and loss of the accepted remittance and the cash discount of the selected accounts receivable to be abated;
said computer system abating said amount of said selected accounts receivable from said selected accounts received, abating said amount of accounts receivable that can be abated from said selected accounts received, and said accounts payable, based on the information of said amount for abatement, the profit and loss of the accepted remittance and the cash discount of said selected accounts receivable to be abated.

22. The method of claim 17 further comprising the execution of the following steps before inputting accounts received sifting terms:
inputting at least one piece of detailed information concerning accounts received in said computer system;
saving at least one of said detailed information of accounts received in said computer system.

23. The method of claim 22, wherein the detailed information of said accounts received comprises notes number, notes due date, billing bank, billing account, bill drawer's name, currency or amount of accounts.

24. The method of claim 17, wherein said accounts received comprises the client's check or a bank confirmation of the balance check sheet.
